(19) United States
(12) Patent Application Publication
(10) Pub. No.: US 2007/0215730 A1
(43) Pub. Date: Sep. 20, 2007

(54) Stress reduction for pulverizer main shaft via thrust bearing modification

(75) Inventors: William N. Martin, Brecksville, OH (US); Ronald D. Mizak, Wadsworth, OH (US)

Correspondence Address: THE BABCOCK & WILCOX COMPANY, PATENT DEPARTMENT, 20 SOUTH VAN BUREN AVENUE, BARBERTON, OH, 44203, US

(73) Assignee: The Babcock & Wilcox Company

(21) Appl. No.: 11/717,345

(22) Filed: Mar. 13, 2007

Related U.S. Application Data
(60) Provisional application No. 60/782,823, filed on Mar. 16, 2006.

(51) Int. Cl. B02C 4/12

(52) U.S. Cl. 241/117

(57) ABSTRACT

A pulverizer mounted on a foundation and comprising a housing enclosing a pulverizing zone and a base plate attached to the housing. The pulverizing zone includes a horizontally disposed rotatable grinding ring, rolling grinding balls positioned on the grinding ring, and means for rotating the grinding ring including an upright main shaft. An annular yoke is attached to the main shaft, and has an outer peripheral portion which is disposed superjacent to the base plate and supports the grinding ring. A load carrying member or thrust bearing is sandwiched between the base plate and the outer peripheral portion of the yoke to minimize the impact, shock, and eccentric loads that are transmitted from the coal grinding process to the main shaft. The load carrying member or thrust bearing achieves this by transmitting the vertical loads directly through the base plate to the housing and therethrough to the pulverizer foundation.

### FIELD AND BACKGROUND OF THE INVENTION

The present invention relates, in general, to the field of coal pulverizers, and more particularly, to stress reduction modifications that provide longer shaft life and reduced incidences of shaft failure in ball-and-race type coal pulverizers.

Coal pulverizers are used to grind, dry and classify raw chunks of coal into fine solids which can be fluidized and fed, for example, to burners used in conjunction with utility and/or industrial boilers or furnaces. As is known to those skilled in the art, several different types of coal pulverizers or coal mills exist today, including one known as the EL pulverizer that was first produced by The Babcock & Wilcox Company in the early 1950's, and is a ball-and-race type pulverizer which employs the ball thrust bearing principle to grind the coal.

In prior art FIGS. 1 and 2, there is shown an EL pulverizer 10 which includes an upper housing section 32 and a lower housing section 34. The lower housing section 34 encloses a gear box 35 mounted on a foundation 37. The upper housing section 32 encloses the pulverizing zone 36 which includes two vertical axis horizontal grinding rings 12 and 14, and a set of balls 16 placed between the grinding rings.

In the EL pulverizer 10 of FIGS. 1 and 2, the lower or bottom grinding ring 12 rests in and is secured (via a key or the like) to a ring seat 44. The ring seat 44 rests upon and is secured to the pulverizer yoke 18. The ring seat 44 is typically made of a conventional steel material, instead of the high hardness materials used in the grinding rings 12 or 14. The ring seat 44 deflects hot incoming primary air from directly impacting the lower grinding ring 12, thereby acting as a heat shield for the lower grinding ring 12. As is known to those skilled in the art, the hot, incoming primary air is used to dry the coal being ground in the pulverizer 10 and to transport the ground coal particles out of the pulverizer 10.

The pulverizer yoke 18 rotates through connection to a rotating, vertical main or drive shaft 20, while the upper or top grinding 14 remains stationary and is spring loaded to provide the pressure for grinding the coal. The pressure required for efficient grinding is obtained from externally adjustable dual purpose springs 22 which are referred to as such, because in addition to providing the loading forces required to efficiently grind the coal, the dual purpose springs 22 also supply the forces required to keep the upper grinding ring 14 from experiencing excessive radial movement, circumferential twisting, and eccentric rotation with respect to the bottom grinding ring 12. The coal is ground by contact with the upper and lower grinding rings 14 and 12, and the balls 16. The upper and lower grinding rings 14 and 12 are each provided with a race having a predefined, matching track contour that engages the balls 16. The force from the upper grinding ring 14 pushes the balls 16 against the coal layer on the lower grinding ring 12. Ground coal is swept from the pulverizing zone 36, defined by the grinding rings 12 and 14 and the balls 16, by air for final particle size classification and subsequent pneumatic transport to one or more coal burners. Oversized coal particles are returned to the pulverizing zone 36. The pulverizer 10 is provided with a gear drive assembly 24 which includes bevel gears 26 and 28 positioned on a horizontal pinion shaft 30 and at the base of the vertical main shaft 20, respectively.

FIG. 2A illustrates another known EL pulverizer 10 which differs from the EL pulverizer 10 of FIGS. 1 and 2 by providing a one piece lower or bottom grinding ring, here designated 12′, which rests upon and is secured to the pulverizer yoke 18. The separate ring seat 44 of FIGS. 1 and 2 is thus omitted.

Typically, the grinding balls 16 operate within a predetermined range of acceptable resistance force exerted on the grinding balls by the coal engaged between the upper and lower grinding rings 14 and 12 (or 12′) and the grinding balls 16. If the acceptable resistance force is exceeded due to, for example, an encounter with coal particles of relatively high hardness and of greater than acceptable size, this may result in impact and shock loads. It can also be appreciated that foreign matter such as tramp iron may be engaged between the upper and lower grinding rings and the grinding balls, and this occurrence may cause the grinding balls to partially leave their original track and result in eccentric loads. The main shaft has a closely fitted mechanical joint with the lower grinding ring and, in addition to driving forces, this joint is subjected, at some frequency, to impact, shock, and eccentric loads from the coal grinding operation which all contributes to severe stresses on the shaft.

Currently, there is some concern as to main shaft failure. It is believed that the shaft failures are initiated by the deterioration of the finely machined outside surface of the tapered portion of the main shaft 20 and the tapered bore surface of the yoke bushing 21. The deterioration is caused by cyclic movement between the contacting surfaces or mutually facing side 23 of the main shaft 20 and the yoke bushing 21. This movement is a consequence of the cyclic or alternating type bending loads experienced at the top end of the main shaft. Because the loads are cyclic, there occurs a progressive form of damage known as fretting. Fretting damage, sometimes referred to as fretting corrosion, is a condition of surface deterioration brought on by very small relative movements between bodies in contact. The fit between the main shaft 20 and the yoke bushing 21 is an interference type fit. This type fit generates a stress concentration or stress multiplier. Also of concern is fatigue failure when stress concentration, cyclic loading and fretting corrosion are combined. Like fretting, fatigue has a definite set of characteristics which combine to identify this failure phenomenon. Pulverizer vibration usually results in high shaft stress levels, and may have a role in main shaft failures. Vibration may be caused by abnormal grinding element wear such as out-of-round wear of balls or rings and, also by failure to maintain a proper air/fuel ratio to the pulverizer 10.

There have been many attempts at correcting main shaft failure frequency such as applying a dry lubricant or a ceramic coating between the yoke end of the main shaft and the yoke bushing bore area, providing the yoke bushing with circumferential grooves, providing the main shaft with a reduced diameter portion below the yoke bushing, employing an anti-seize compound at the main shaft-to-yoke bushing joint, using a full contact yoke bushing or one with an undercut center portion, shot peening, and nitriding as a surface hardening process. Remedial efforts notwithstanding, even carefully fitted taper joints, when subjected to cyclic bending forces often exhibit vulnerability to fatigue failure of main shafts because of fretting and stress produced at the joint between the main shaft and the yoke bushing.

In accordance with the present invention, longer pulverizer shaft wear life and reduced incidences of shaft failure are achieved by minimizing the impact, shock and eccentric loads from the grinding process that are transmitted to the shaft, and thus provide reliable ball-and-race type coal pulverizer performance.

### SUMMARY OF THE INVENTION

The present invention is directed at a ball-and-race type pulverizer mounted on a foundation and comprising a housing enclosing a pulverizing zone and a gear box, a top bearing plate or base plate attached to the housing, the pulverizing zone including a horizontally disposed rotatable grinding ring, rolling grinding elements positioned on the grinding ring, and means for rotating the grinding ring including an upright drive shaft or main shaft. An annular yoke is connected to the main shaft, and the yoke has an outer peripheral portion which is disposed superjacent to the base plate and supports the grinding ring. In accordance with the invention, a thrust bearing or stress reduction member is sandwiched between the outer peripheral portion of the yoke and the base plate to minimize the impact, shock, and eccentric loads that are transmitted from the coal grinding process to the main shaft. The thrust bearing achieves this by transmitting the vertical loads directly through the base plate to the housing and therethrough to the pulverizer foundation. A seal assembly is mounted on the outboard side of the thrust bearing to isolate the bearing from coal dust escaping the pulverizing zone.

In one embodiment of the invention, the thrust bearing is a cylindrical roller thrust bearing and includes an upper raceway and a lower raceway, and a plurality of cylindrical rollers respectively interposed between the upper and lower raceway.

In another embodiment of the invention, the thrust bearing is a ball thrust bearing and includes an upper raceway and a lower raceway, and a plurality of balls, respectively interposed between the upper raceway and the lower raceway.

In still another embodiment of the invention, the thrust bearing is a tapered thrust roller bearing and includes a tapered upper raceway and a tapered lower raceway, and a plurality of tapered rollers respectively interposed between the upper raceway and the lower raceway. While both of the raceways can be tapered, alternatively only one of the raceways (either an upper or a lower raceway) may be tapered, with the other raceway (either an upper or a lower raceway) being flat, with the plurality of tapered rollers being located accordingly.

In a further embodiment of the invention, the thrust bearing is a friction bearing and includes an upper raceway and a lower raceway spaced from each other and having a sliding surface on a mutually facing side.

In a still further embodiment of the invention, the friction bearing includes a lubricating fluid between the mutually facing side of the upper raceway and the lower raceway.

In another embodiment of the invention, the thrust bearing includes a lower raceway, and a plurality of load bearing idler rollers respectively interposed between the lower raceway and the yoke, the idler rollers being mounted on the yoke.

In still another embodiment of the invention, the thrust bearing includes an upper raceway, and a plurality of load bearing idler rollers respectively interposed between the upper raceway and the yoke, the idler rollers being mounted on the base plate.

These and other features and advantages of the present invention will be better understood and its advantages will be more readily appreciated from the detailed description of the preferred embodiment, especially when read with reference to the accompanying drawings.

### BRIEF DESCRIPTION OF THE DRAWINGS

FIG. 1 is a sectional side view of a prior art type EL ball and race pulverizer, wherein the lower or bottom grinding ring rests in and is secured to a ring seat which rests upon and is secured to the pulverizer yoke;

FIG. 2 is a detail cutaway view of a portion of the prior art EL pulverizer shown in FIG. 1;

FIG. 2A is a detail cutaway view of a portion of another prior art EL pulverizer similar to shown in FIGS. 1 and 2, wherein the lower or bottom grinding ring is a one-piece grinding ring;

FIG. 3 is a detail cutaway view of a portion of an EL pulverizer wherein, according to the present invention, a cylindrical roller type thrust bearing is interposed between the yoke and the base plate;

FIG. 4 is a detail cutaway view of a portion of an EL pulverizer wherein, according to the present invention, a ball type thrust bearing is interposed between the yoke and the base plate;

FIG. 5 is a detail cutaway view of a portion of an EL pulverizer wherein, according to the present invention, a tapered roller type thrust bearing is interposed between the yoke and the base plate;

FIG. 6 is a detail cutaway view of a portion of an EL pulverizer wherein, according to the present invention, a slide type thrust bearing is interposed between the yoke and the base plate;

FIG. 7 is a detail cutaway view of a portion of an EL pulverizer wherein, according to the present invention, a thrust bearing is interposed between the yoke and a base plate, and includes a plurality of load bearing idler rollers mounted on the yoke; and

FIG. 8 is a detail cutaway view of a portion of an EL pulverizer wherein, according to the present invention, a thrust bearing is interposed between the yoke and a base plate, and includes a plurality of load bearing idler rollers mounted on the base plate.

### DESCRIPTION OF THE PREFERRED EMBODIMENT

Reference will hereinafter be made to the accompanying drawings wherein like numerals designate the same or functionally similar elements throughout the various figures.

The present invention resides in providing stress reduction for the pulverizer main shaft by placing a load carrying member or thrust bearing between the shaft-driven yoke and a housing supported to minimize the impact, shock, and eccentric loads from the grinding process to the pulverizer main shaft. This is accomplished by the thrust bearing which transmits the vertical loads directly through the base plate to the housing and therethrough to the pulverizer foundation.

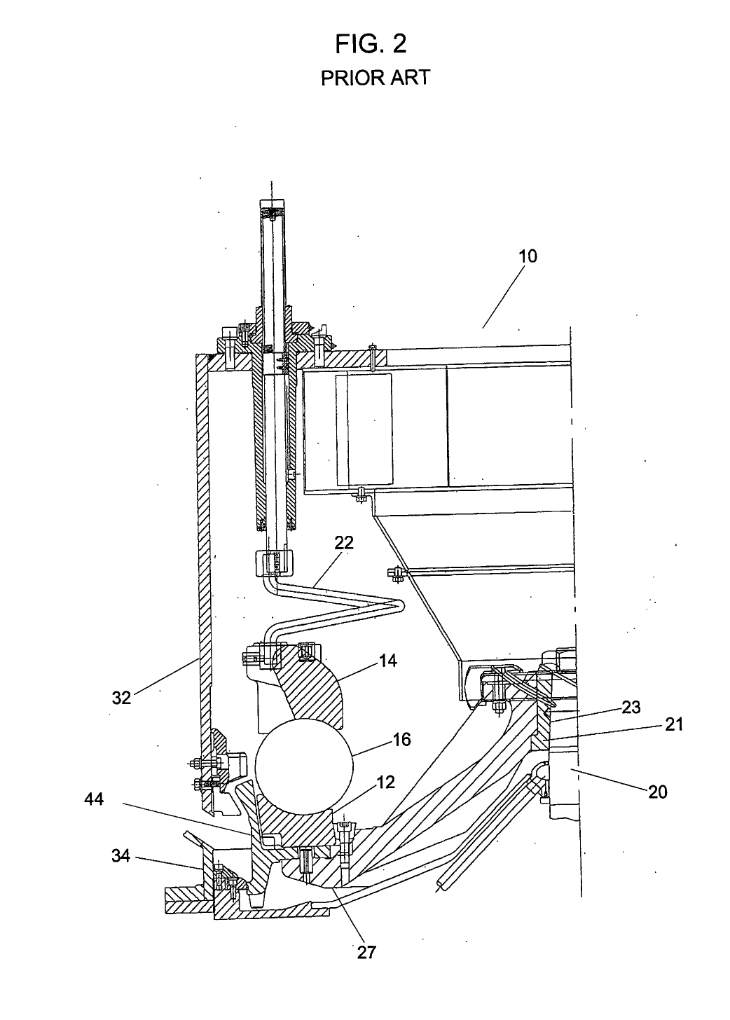

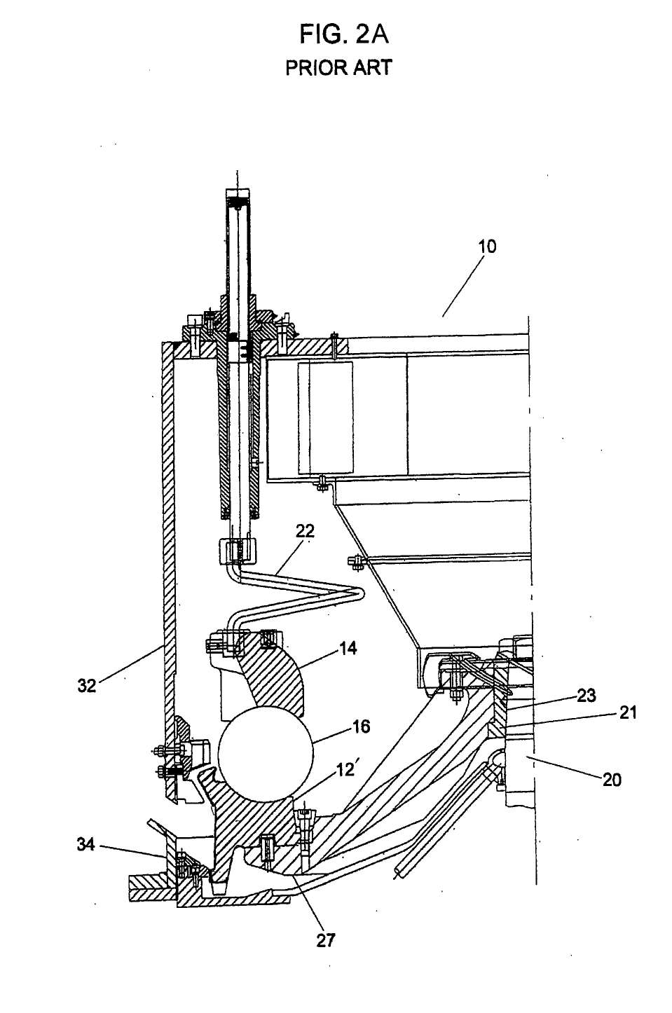

It will be appreciated by those skilled in the art that some of the following embodiments of the present invention employ traditional thrust bearing concepts. A thrust bearing is a bearing which is designed to handle axial loads, and traditionally those axial loads are handled by means of intercooperating raceways and rolling elements, or by intercooperating smooth, sliding surfaces. In the case of rolling elements, the rolling elements can be in the form of cylindrical rollers, tapered rollers, or rolling balls. The present invention not only utilizes such traditional thrust bearing concepts and methods, but also includes apparatus and methods of handling axial loads which include use of plural, individual idler rollers arranged in such a fashion so as to handle the axial loads. Accordingly, for the purpose of the present invention, the term thrust bearing or load carrying member embraces any structures as disclosed herein as well as equivalents thereof which are intended to carry or accommodate such axial loads. Further, in the setting of the present invention, the axial loads which have to be dealt with are those axial loads which are aligned substantially parallel to the vertical axis of the pulverizer main shaft, regardless of how these axial loads may be directed or transmitted through the thrust bearing or load carrying members used in the present invention. Finally, while the majority of the FIGS. in the present disclosure illustrate ball-and-race pulverizers 10 which employ a lower or bottom grinding ring 12 which rests in and is secured (via a key or the like) to a ring seat 44, and wherein the ring seat 44 rests upon and is secured to the pulverizer yoke 18, the concepts of the present invention are not limited only to pulverizers 10 provided with such types of lower or bottom grinding rings 12. The concepts of the present invention also apply to ball-and-race pulverizers 10 which employ a one piece lower or bottom grinding ring 12′, which rests upon and is secured to the pulverizer yoke 18, such as illustrated in FIG. 2A, for example.

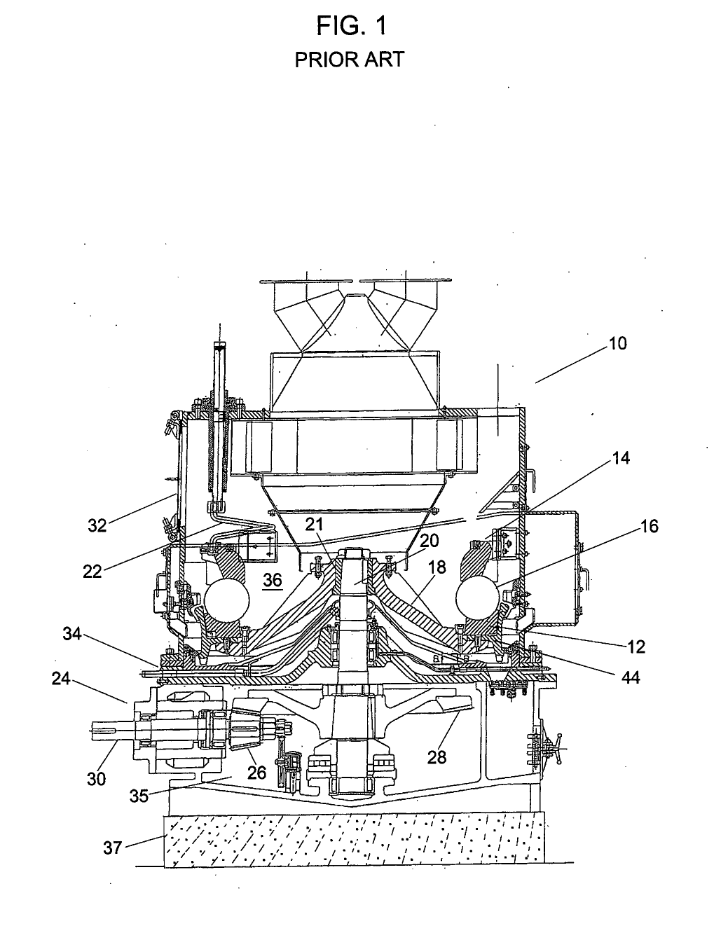

Referring again to prior art FIGS. 1 and 2, and 2A, there is shown the ball-and-race pulverizer 10 including the upper housing 32 and the lower housing 34. The upper housing 32 encloses the yoke 18 which rotates through connection to the rotating vertical main shaft 20. A tapered top end portion of main shaft 20 lies within the bore of yoke 18 and is surrounded by the yoke bushing 21. The fretting damage occurring as the result of cyclic or alternate type bending loads generated by the pulverizer operation and the tight fit required between the mating surfaces at the top end of the main shaft 20 and the yoke bushing 21 cause bending fatigue stress and develop a stress concentration which may lead to failures of the main shaft 20.

A means for preventing the damage due to fretting is to reduce the cyclic movement between the main shaft 20 and the yoke bushing 21. One approach to reducing this cyclic movement is to minimize the impact, shock, and eccentric loads from the grinding process that are transmitted to the main shaft 20.

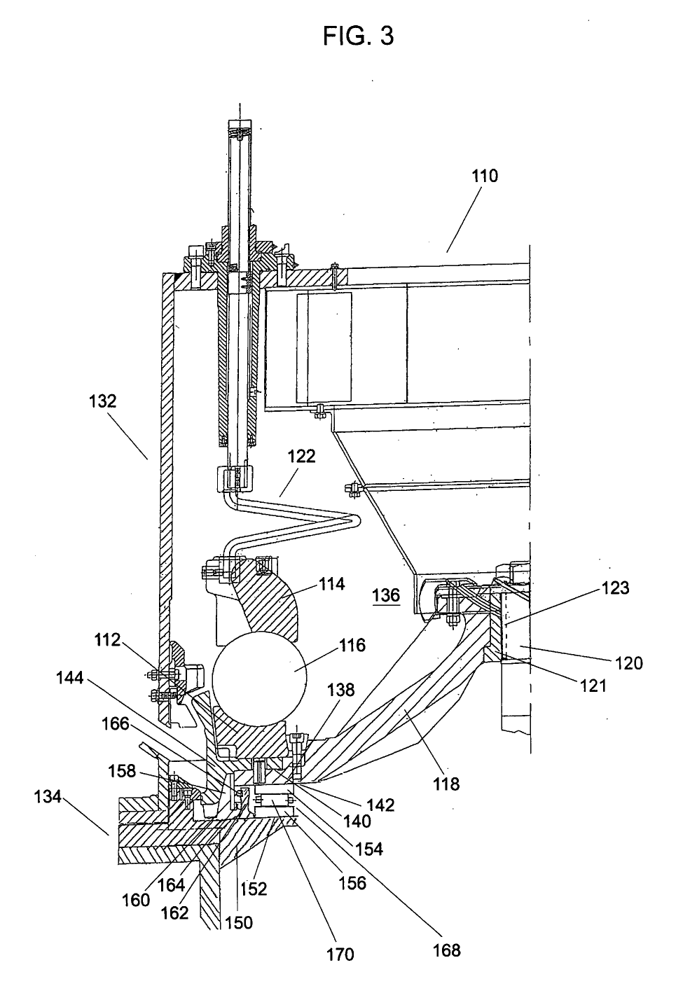

In order to accommodate the retrofitting of the present invention to the prior art EL pulverizer shown in FIGS. 1 and 2, and 2A, the connection between the upper end of the main shaft 20 and the yoke bushing 21 is modified from that of the prior art EL pulverizer by eliminating the respective taper on a mutually facing side 23 of the upper end of the main shaft 20 and the yoke bushing 21, and by eliminating the hump 27, shown in prior art FIGS. 1 and 2, and 2A, and leveling the lower face or underside of the outer peripheral portion of the yoke 18, as seen in FIGS. 3 through 8.

Referring to FIGS. 3 through 8, there is shown a detail cutaway view of a portion of an EL pulverizer 110 which includes a cylindrical upper housing section 132 and a lower housing section 134. The lower housing section 134 encloses a gear box, not shown, and is mounted on a foundation, not shown. The upper housing section 132 encloses the pulverizing zone 136 that includes the grinding parts of the pulverizer 110 which comprise a rotatable yoke 118 connected to the upper end of a rotating main shaft 120. A yoke bushing 121 is interposed between the yoke 118 and the shaft 120 and, in accordance with the present invention, the mutual face 123 of the yoke bushing 121 and the shaft 120 are straight. The yoke 118 has an outer peripheral portion 138 with leveled upper and lower faces 140 and 142, respectively. A lower or bottom grinding ring 112 rests in and is secured (via a key or the like) to a ring seat 144 and rests upon and is secured to the outer peripheral portion 138 of yoke 118. The upper face of the lower grinding ring 112 is shaped to form a track for a circular row of rolling grinding balls 116. The lower face of the upper grinding ring 114 is shaped to form a track for the rolling balls 116. A resilient grinding pressure is exerted downwardly on the grinding parts by coil springs 122. An annular base plate or bearing plate 150 has a level or flat upper surface 152, and is attached to the upper and lower housings 132 and 134, respectively. A thrust bearing or load carrying member is interposed between the upper surface 152 of bearing plate 150 and the lower face 142 of the yoke 118. The thrust bearing or load carrying member includes an upper raceway 154 and a lower raceway 156. The upper raceway 154 is connected to the level underside or lower face 142 of the yoke 118. The lower raceway 156 is connected to the level upper surface 152 of the base plate 150. A seal assembly 158 isolates the stress reduction member from the pulverizing zone 136. The seal assembly 158 may be any of a number of known seals practiced in the art such as, for example, labyrinth-air seals, labyrinth-brush seals, and packing-brush seals. The seal assembly 158, as schematically shown, includes a pair of laterally spaced skirt plates 160 and 162, and a brush seal 164 and packing 166 interposed between the skirt plates 160 and 162. The skirt plate 160 is attached to the distal end of the yoke 118, and the skirt plate 162 is attached to the base plate 150.

As shown in FIG. 3, the thrust bearing or load carrying member is a thrust bearing 168 which includes one of a plurality of cylindrical rollers 170, respectively interposed between the upper raceway 154 and the lower raceway 156.

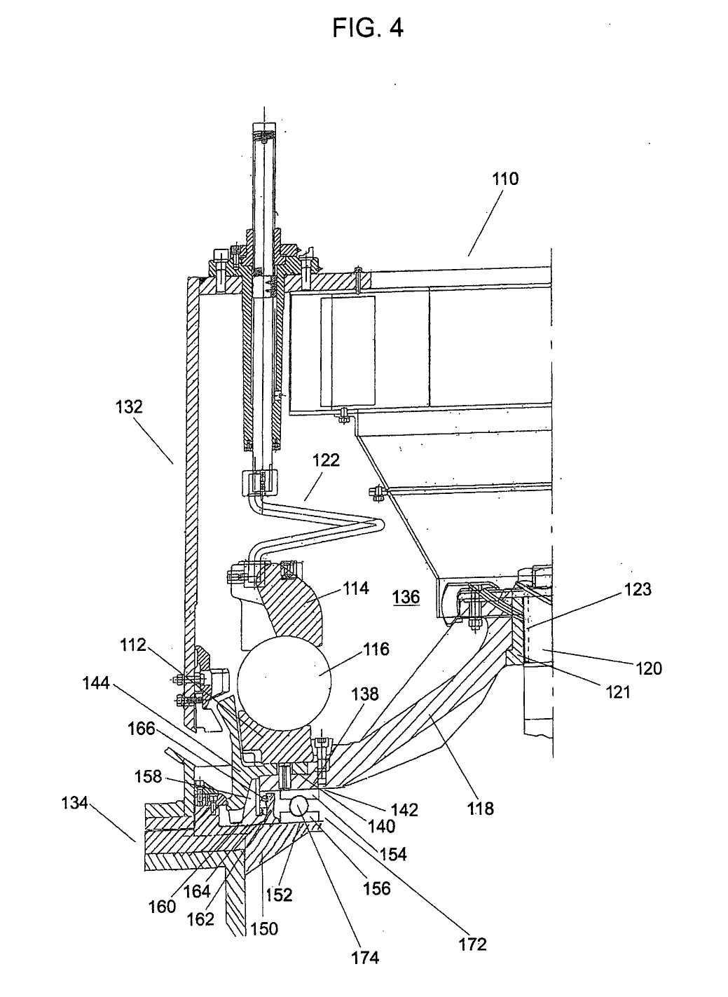

As shown in FIG. 4, the thrust bearing or load carrying member is a thrust bearing 172 which includes one of a plurality of balls 174, respectively interposed between the upper raceway 154 and the lower raceway 156.

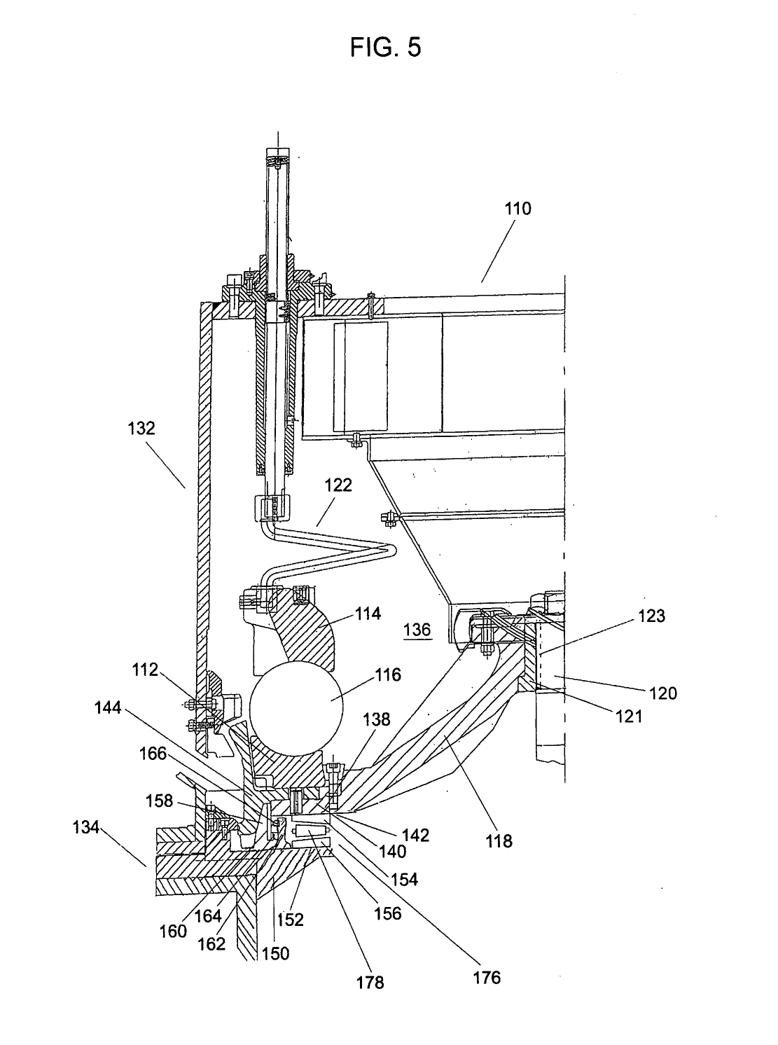

As shown in FIG. 5, the thrust bearing or load carrying member is a thrust bearing 176 which includes one of a plurality of tapered rollers 178, respectively interposed between the upper raceway 154 and the lower raceway 156, with each of the raceways 154 and 156 being tapered or conically-shaped to match the taper of the tapered rollers 178. While both of the raceways can be tapered, alternatively only one of the raceways (either an upper 154 or a lower 156 raceway) may be tapered, with the other raceway (either an upper 154 or a lower 156 raceway) being flat, with the plurality of tapered rollers 178 being located accordingly.

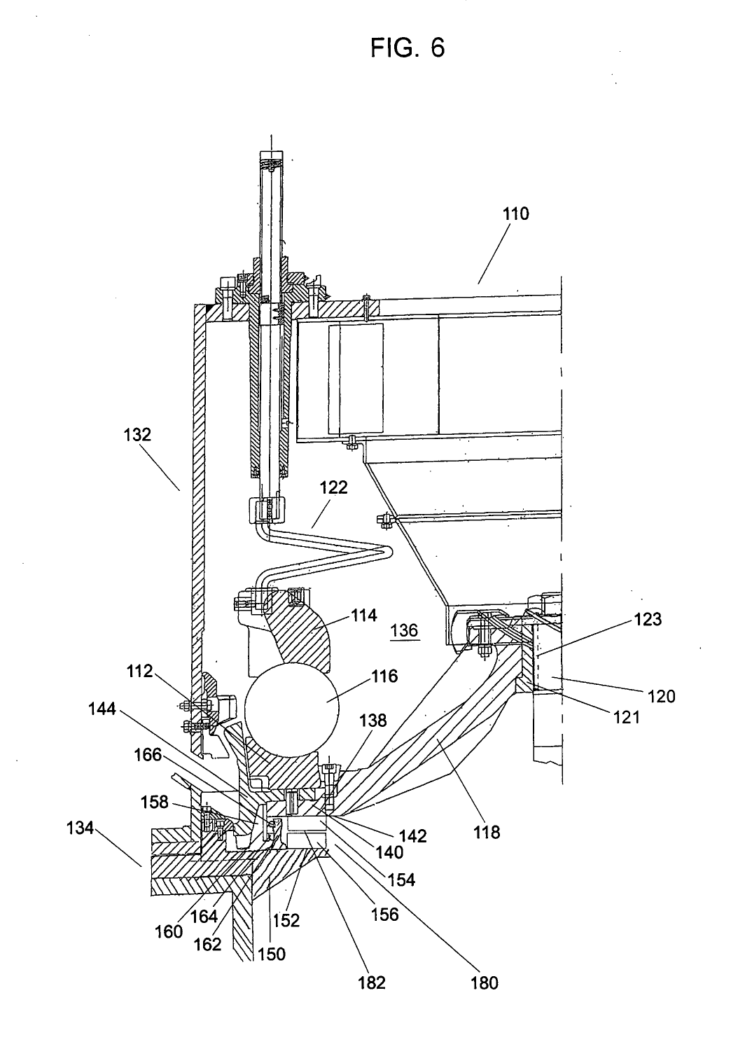

As shown in FIG. 6, the thrust bearing or load carrying member is a fluid lubricated friction type thrust bearing 180 which includes the upper raceway 154 and lower raceway 156 separated by a narrow space 182. A lubricating fluid, either gas or liquid, is introduced in the space 182 and acts as the actual bearing surface between the stationary base plate 150 and the rotating yoke 118. For example, liquid lubricants comprising oil, more complex ferro-magnetic fluids or even air have been utilized in hydrodynamic bearing systems.

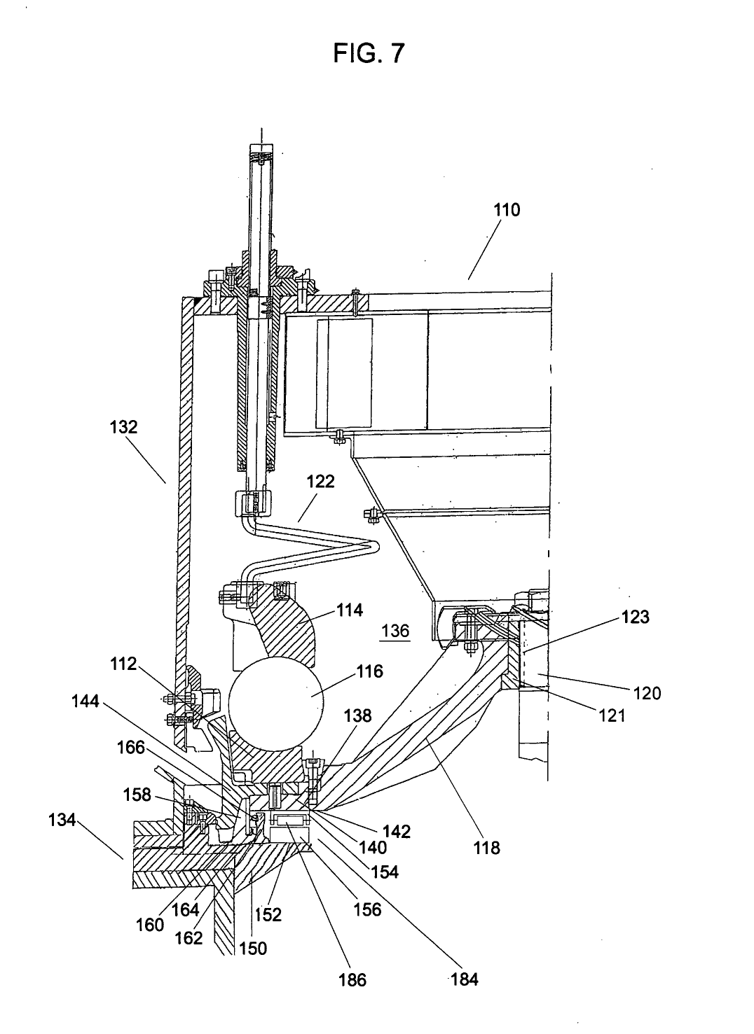

As shown in FIG. 7, the thrust bearing or load carrying member is a thrust bearing 184 which includes one of a plurality of load bearing idler rollers 186 interposed between the lower raceway 156 and the yoke 118. The load bearing idler rollers 186 are mounted on the yoke 118.

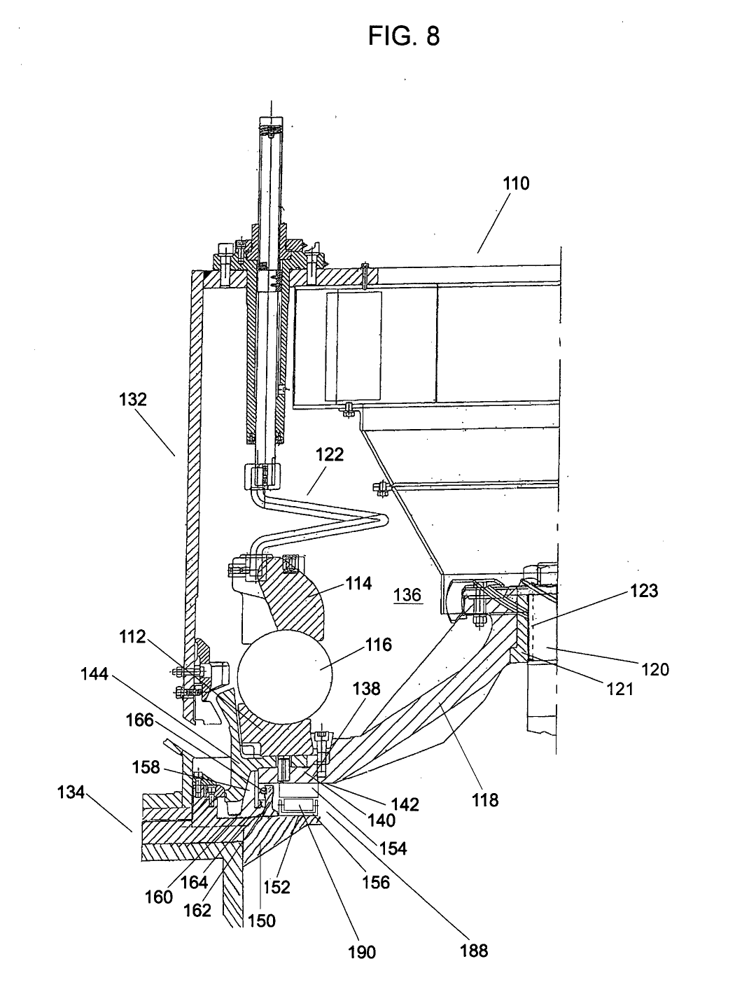

As shown in FIG. 8, the thrust bearing or load carrying member is a thrust bearing 188 which includes one of a plurality of load bearing idler rollers 190 interposed between the upper raceway 154 and the yoke 118. The load bearing idler rollers 190 are mounted on the base plate 150.

While specific embodiments of the invention have been shown and described in detail to illustrate the application of the principles of the invention, it will be understood that the invention may be embodied otherwise without departing from such principles. For example, the present invention may be applied in new construction involving type EL pulverizers, or to the repair, replacement, and modification or retrofitting of existing type EL pulverizers. Thus, while the present invention has been described above with reference to particular means, materials, and embodiments, it is to be understood that this invention may be varied in many ways without departing from the spirit and scope thereof, and therefore is not limited to these disclosed particulars but extends instead to all equivalents within the scope of the following claims.

We claim:

1. An assembly comprising an upright rotatable shaft extending into a rotatable yoke, a tubular bushing interposed between the shaft and the yoke, a base plate, an outer peripheral portion of the yoke facing the base plate, and a load carrying member sandwiched between the outer peripheral portion of the yoke and the base plate.

2. The assembly according to claim 1 wherein the load carrying member is a thrust bearing.

3. The assembly according to claim 2, wherein the thrust bearing includes an upper raceway and a lower raceway, and a plurality of cylindrical rollers respectively interposed between the upper raceway and the lower raceway.

4. The assembly according to claim 2, wherein the thrust bearing includes an upper raceway and a lower raceway, and a plurality of balls respectively interposed between the upper raceway and the lower raceway.

5. The assembly according to claim 2, wherein the thrust bearing includes an upper raceway and a lower raceway, at least one of the upper and lower raceways being tapered, and a plurality of tapered rollers respectively interposed between the upper raceway and the lower raceway.

6. The assembly according to claim 2, wherein the thrust bearing includes an upper raceway and a lower raceway spaced from each other and having a sliding surface on a mutually facing side.

7. The assembly according to claim 6, wherein the thrust bearing includes a lubricating fluid in the space between the upper raceway and the lower raceway.

8. The assembly according to claim 2, wherein the thrust bearing includes a lower raceway, a plurality of load bearing idler rollers interposed between the lower raceway and the yoke, the idler rollers being mounted on the yoke.

9. The assembly according to claim 2, wherein the thrust bearing includes an upper raceway, a plurality of load bearing idler rollers interposed between the upper raceway and the yoke, the idler rollers being mounted on the base plate.

10. A pulverizer comprising a housing enclosing a pulverizing zone, a base plate attached to the housing, the pulverizing zone including a horizontally disposed rotatable grinding ring, rolling grinding elements positioned on the grinding ring, means for rotating the grinding ring including an upright main shaft, an annular yoke mounted on the main shaft, the yoke having an outer peripheral portion disposed superjacent the base plate and supporting the grinding ring, a load carrying member sandwiched between the outer peripheral portion of the yoke and the base plate, and a seal assembly for isolating the load carrying member from the pulverizing zone.

11. The pulverizer according to claim 10, wherein the load carrying member is a thrust bearing.

12. The pulverizer according to claim 11, wherein the thrust bearing is a cylindrical roller bearing.

13. The pulverizer according to claim 11, wherein the thrust bearing is a ball bearing.

14. The pulverizer according to claim 11, wherein the thrust bearing is a tapered roller bearing.

15. The pulverizer according to claim 11, wherein the thrust bearing is a friction bearing.

16. The pulverizer according to claim 15, wherein the thrust bearing is a fluid lubricated friction bearing.

17. The pulverizer according to claim 11, wherein the thrust bearing includes a load bearing idler roller mounted on the yoke.

18. The pulverizer according to claim 11, wherein the thrust bearing includes a load bearing idler roller mounted on the base plate.

19. The pulverizer according to claim 10, wherein the seal assembly includes a pair of laterally spaced skirt plates.

20. The pulverizer according to claim 19, wherein one skirt plate is attached to the yoke and the other skirt plate is attached to the base plate.

21. The pulverizer according to claim 19, including sealing means interposed between the skirt plates.

22. A method of retrofitting a pulverizer having a housing enclosing a pulverizing zone, a base plate attached to the housing, a horizontally disposed rotatable grinding ring located in the pulverizing zone, rolling grinding elements positioned on the grinding ring, an upright main shaft for rotating the grinding ring, the main shaft having a tapered end, an annular yoke mounted on the tapered end of the main shaft, the yoke having an outer peripheral portion disposed superjacent the base plate and supporting the grinding ring, a tubular bushing interposed between the yoke and the tapered end of the main shaft, the bushing having a tapered inner periphery facing the shaft, comprising the step of: positioning a thrust bearing between the outer peripheral portion of the yoke and the base plate.

23. The method according to claim 22, further comprising the step of providing a seal assembly for isolating the thrust bearing from the pulverizing zone.

24. The method according to claim 22, further comprising the step of eliminating the tapers from the inner periphery of the bushing and the end of the shaft.

25. The method according to claim 22, further comprising the step of leveling the underside of the outer peripheral portion of the yoke.

26. The method as in one of claims 22-25, in which the thrust bearing is a cylindrical roller bearing.

27. The method as in one of claims 22-25, in which the thrust bearing is a ball bearing.

28. The method as in one of claims 22-25, in which the thrust bearing is a tapered roller bearing.

29. The method as in one of claims 22-25, in which the thrust bearing is a friction bearing.

30. The method according to claim 29, further comprising the step of fluid lubricating the friction bearing.

31. The method as in one of claims 22-25, in which the thrust bearing includes a load bearing idler roller mounted on the yoke.

32. The method as in one of claims 22-25, in which the thrust bearing includes a load bearing idler roller mounted on the base plate.

33. The method according to claim 23, further comprising the step of providing a pair of laterally spaced skirt plates between outer peripheral portion of the yoke and the base plate.

34. The method according to claim 33, further comprising the step of attaching one of the skirt plates to the yoke and the other skirt plate to the base plate.

35. The method according to claim 33 or 34, further comprising the step of positioning a sealing means between the skirt plates.
